(19) United States
(12) Patent Application Publication
(10) Pub. No.: US 2026/0218846 A1
(43) Pub. Date: Jul. 30, 2026

(54) WALL MOUNTED MOUNTING BRACKET FOR AUDIOVISUAL DEVICE

(71) Applicant: Crestron Electronics, Inc., Rockleigh, NJ (US)

(72) Inventor: Kian-Mun Kong, Rivervale, NJ (US)

(73) Assignee: Crestron Electronics, Inc., Rockleigh, NJ (US)

(21) Appl. No.: 19/245,467

(22) Filed: Jun. 23, 2025

Related U.S. Application Data
(60) Provisional application No. 63/750,478, filed on Jan. 28, 2025.

(51) Int. Cl. F16M 13/02; F16M 11/10

(52) U.S. Cl. CPC F16M 13/02; F16M 11/10; F16M 2200/022

(57) ABSTRACT

A mounting bracket is disclosed. A first plate is configured to be securable to a vertical mounting surface. A second plate is configured to be securable to an audiovisual device. At least one hinge/clutch assembly has a pivot axis. The first plate and the second plate are each attached at one end to the at least one hinge/clutch assembly such that the second plate is rotatable away from the first plate at least part way about the pivot axis of the at least one hinge/clutch assembly.

### CROSS-REFERENCE TO RELATED APPLICATIONS

This application claims the benefit of the filing date of United States Provisional Ser. No. 63/750,478 (“the '478 application”), filed Jan. 28, 2025, the disclosure of which is incorporated herein by reference.

This application is also related to United States Application No. Ser. No. 29/987,932, titled “WALL MOUNTED MOUNTING BRACKET FOR ELECTRONIC DEVICE” and filed Jan. 28, 2025, the same date as the '478 application, the disclosure of which is incorporated herein by reference.

### BACKGROUND OF THE INVENTION

### Technical Field

The present embodiments relate to mounting brackets and, more particularly, to mounting brackets that are securable to a wall or other mounting surface and configured for mounting an audiovisual device.

### Background Art

In recent years, the percentage of the global workforce that is on a remote work schedule or hybrid working schedule has grown significantly. With their workforces now being scattered geographically, businesses are faced with the challenge of giving each worker access to the tools needed to collaborate with other employees remotely. In response, there have been numerous innovations in collaboration technology in recent years that address this challenge.

One such innovation is video conferencing and, more recently, the introduction of professional video conferencing systems. These video conferencing systems are formed of various discrete components that individually function to capture and transmit video, audio, digital files, shared digital screens, and other content. By connecting these discrete components together, a unified solution is formed that facilitates long-distance communications and collaboration between individuals and groups.

Though modern smartphones and personal computers can achieve some of these functions using built-in and/or add-on features or devices, a professional video conferencing system must meet higher standards of video and audio quality, security, connectivity, system management, and scalability. Therefore, web-based video meeting platforms have been developed to carry out interactive virtual meetings in real-time among people located in different locations or geographic areas. Such platforms provide screen-sharing capabilities that enable users to share working documents within any sized group, present content, and perform live edits while receiving peer feedback.

Additionally, various types of technology and equipment are needed for a professional video conferencing system, including displays, cameras, microphones, and speakers. Though the choice of equipment often depends on user needs and the space used, it is desirable for a professional video conferencing system to employ professional video conferencing cameras with features such as speaker tracking and auto-framing to provide higher-definition video calls. It is also often desirable for a professional video conferencing system to incorporate higher-quality microphones that employ noise-canceling as well as to employ higher-quality speakers.

One approach to providing such cameras, microphones, and speakers for a professional video conferencing system is to obtain these devices separately, install each device individually in a conference room, and then integrate the devices into the video conferencing system. A more desirable alternative is to opt for an all-in-one video conferencing system such as the Crestron® Videobar 70 which combines such higher-quality video conferencing cameras, microphones, and speakers in a single product.

The Crestron® Videobar 70 is an all-in-one-collaboration bar in which four high-resolution cameras, stereo speakers, and beamforming microphones are provided in a single, easily deployable device. The four high-resolution cameras are used to provide intelligent video capabilities that include group framing, speaker tracking, and picture-in-picture. A wide-angle camera is provided for full room views and to image individuals closer to the front of a room. Three narrow-field-of-view cameras are arranged in an array and can work together to capture individuals further away in high-resolution.

In many conference room applications, it desirable to mount the Videobar 70 to the wall of a conference room. It is further desirable to mount the Videobar 70 to the wall at a location directly above or below a display mounted to the same wall of the conference room. It is still further desirable that the cables that provide power and data connections to the Videobar 70 and between the Videobar 70and the display be hidden and not visible to those participating in the video conference.

It is therefore desirable to provide a mounting bracket that enables the installation of the Videobar 70 to a wall of a conference room in accordance with the above.

### SUMMARY OF THE INVENTION

It is to be understood that both the general and detailed descriptions that follow are exemplary and explanatory only and are not restrictive.

### Disclosure of Invention

In accordance with an aspect, a mounting bracket comprises (a) a first plate configured to be securable to a vertical mounting surface; (b) a second plate configured to be securable to an audiovisual device; and (c) at least one hinge/clutch assembly having a pivot axis, the first plate and the second plate each being attached at one end to the at least one hinge/clutch assembly such that the second plate is rotatable away from the first plate at least part way about the pivot axis of the at least one hinge/clutch assembly.

According to a further aspect, a mounting bracket comprises (a) a first plate configured to be securable to a vertical mounting surface, the first plate narrowing at one end to form at least one extension region, a first arm being disposed adjacent to one side of the at least one extension region and extending away from, and perpendicular to, a surface of the first plate; (b) a second plate configured to be securable to an audiovisual device, the second plate narrowing at one end to form at least one further extension region, a second arm being disposed adjacent to one side of the at least one further extension region and extending away from, and perpendicular to, a surface of the second plate; and (c) at least one hinge/clutch assembly having a pivot axis; (d) wherein (1) the first arm is disposed adjacent to the second arm and has an end portion that overlaps an end portion of the second arm, (2) a first opening formed in the end portion of the first arm overlies a second opening formed in the end portion of the second arm, (3) a body portion of the at least one hinge/clutch assembly is disposed on one side of the first and second openings, an end portion of the at least one hinge/clutch assembly is disposed on an opposing side of the first and second openings, and a remaining portion of the at least one hinge/clutch assembly extends through the first and second openings, and (4) the pivot axis extends through the first and second openings, the second plate thereby being rotatable away from the first plate at least part way about the pivot axis of the at least one hinge/clutch assembly.

According to a still further aspect, a mounting bracket comprises (a) a first plate configured to be securable to a vertical mounting surface, the first plate including (1) a first surface that is configured to face the mounting surface upon the first plate being secured to the mounting surface, and (2) an opposing second surface that is configured to face away from the mounting surface upon the first plate being secured to the mounting surface, (3) the first plate narrowing at one end to form a pair of extension regions, each having a respective first arm disposed adjacent to one side of that extension region and extending away from, and perpendicular to, the second surface of the first plate; (b) a second plate configured to be securable to an audiovisual device, the second plate including (1) a first surface that is configured to face the audiovisual device upon the audiovisual device being secured to the second plate, and (2) an opposing second surface that is configured to face away from the audiovisual device upon the audiovisual device being secured to the second plate, (3) the second plate narrowing at one end to form a pair of further extension regions, each having a respective second arm disposed adjacent to one side of that further extension region and extending away from, and perpendicular to, the second surface of the second plate, wherein (4) the first arm that extends from each one of the pair of extension regions of the first plate is disposed adjacent to the second arm that extends from a corresponding one of the pair of further extension regions of the second plate and has an end portion that overlaps an end portion of that second arm, and (5) a first opening formed in the end portion of each first arm overlies a second opening formed in the end portion of its adjacent second arm; and (c) a pair of hinge/clutch assemblies, wherein (1) an ending of one of the pair of extension regions of the first plate and an adjacent ending of one of the pair of further extension regions of the second plate are each attached to a respective one of the pair of hinge/clutch assemblies, such that (A) a body portion of that hinge/clutch assembly is disposed on one side of the overlying first and second openings respectively formed in the end portions of the first and second arms that respectively extend from one of the pair of extension regions of the first plate and the one of the pair of further extension regions of the second plate, (B) an end portion of that hinge/clutch assembly is disposed on an opposing side of the overlying first and second openings, and (C) a remaining portion of that hinge/clutch assembly extends through the overlying first and second openings, and (2) an ending of another of the pair of extension regions of the first plate and an adjacent ending of another of the pair of further extension regions of the second plate are each attached to another of the pair of hinge/clutch assemblies, such that (A) a body portion of that hinge/clutch assembly is disposed on one side of the overlying first and second openings respectively formed in the end portions of first and second arms that respectively extend from another of the pair of extension regions of the first plate and another of the pair of further extension regions of the second plate, (B) an end portion of that hinge/clutch assembly is disposed on an opposing side of the overlying first and second openings, and (C) a remaining portion of that hinge/clutch assembly extends through the overlying first and second openings, (3) the pair of hinge/clutch assemblies thereby having a common pivot axis, each one of the pair of hinge/clutch assemblies being configured to be rotatable about the common pivot axis upon exertion of a force on the second plate and fixed upon removal of the force; (d) wherein a gap is formed between the first plate and the second plate, the gap being configured to permit cabling of the audiovisual device to pass through the gap.

### BRIEF DESCRIPTION OF DRAWINGS

The accompanying figures further illustrate the present embodiments.

The components in the drawings are not necessarily drawn to scale, emphasis instead being placed upon clearly illustrating the principles of the present embodiments. In the drawings, like reference numerals designate corresponding parts throughout the several views.

### BRIEF DESCRIPTION OF THE SEVERAL VIEWS OF THE DRAWING

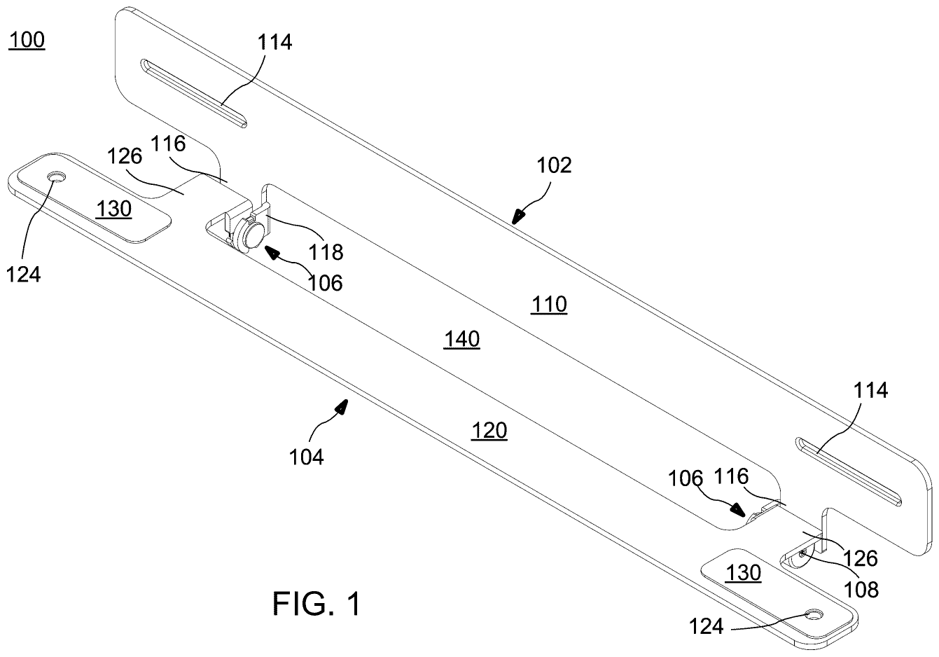

FIG. 1 is a top perspective view of a mounting bracket according to an embodiment.

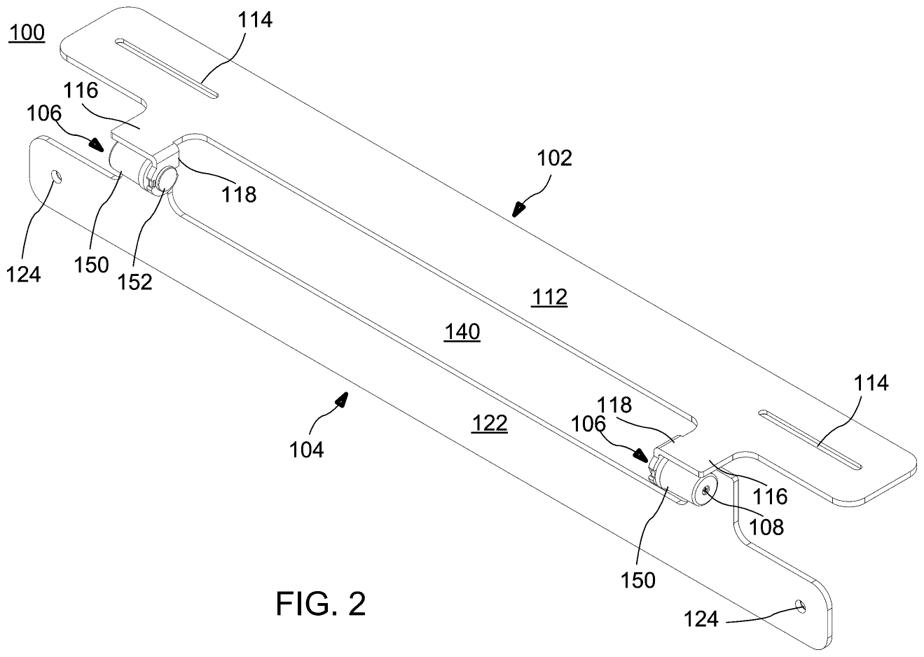

FIG. 2 is a bottom perspective view of the mounting bracket of FIG. 1.

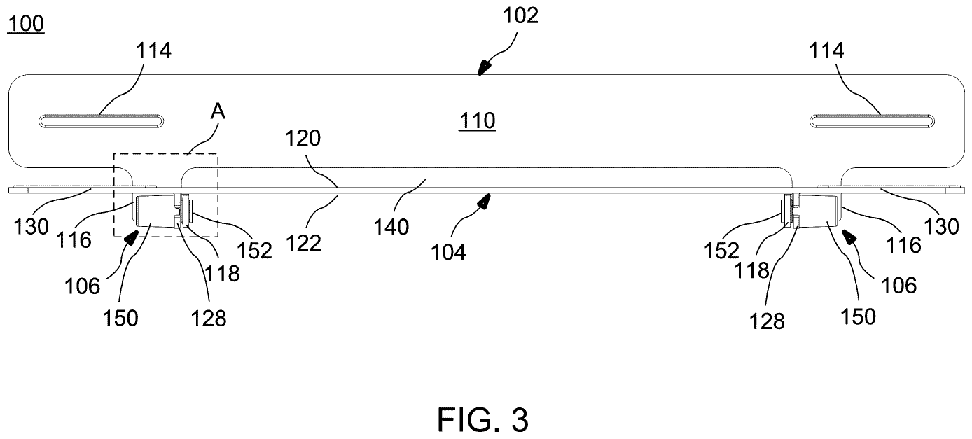

FIG. 3 is a front elevation view of the mounting bracket of FIG. 1.

FIG. 3A is an enlarged view of region “A” of the front elevation view shown in FIG. 3.

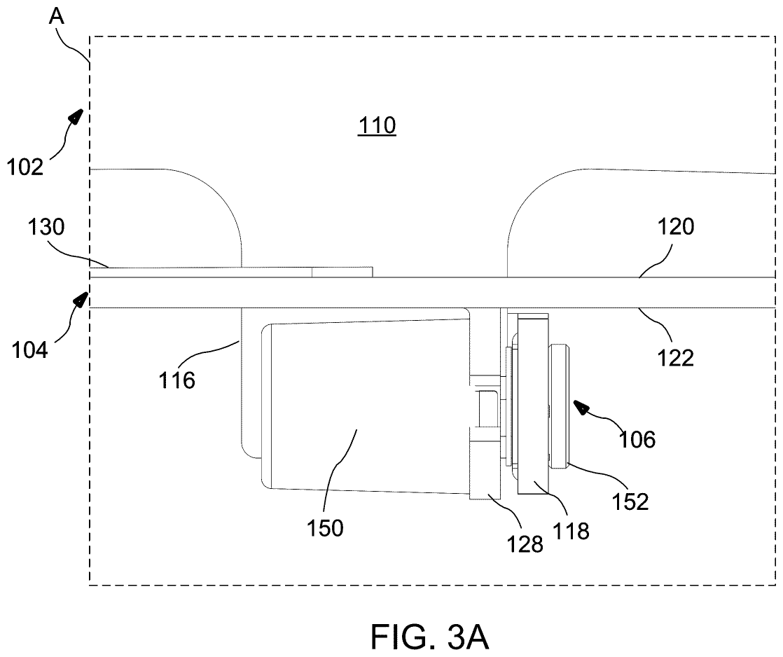

FIG. 4 is a rear elevation view of the mounting bracket of FIG. 1.

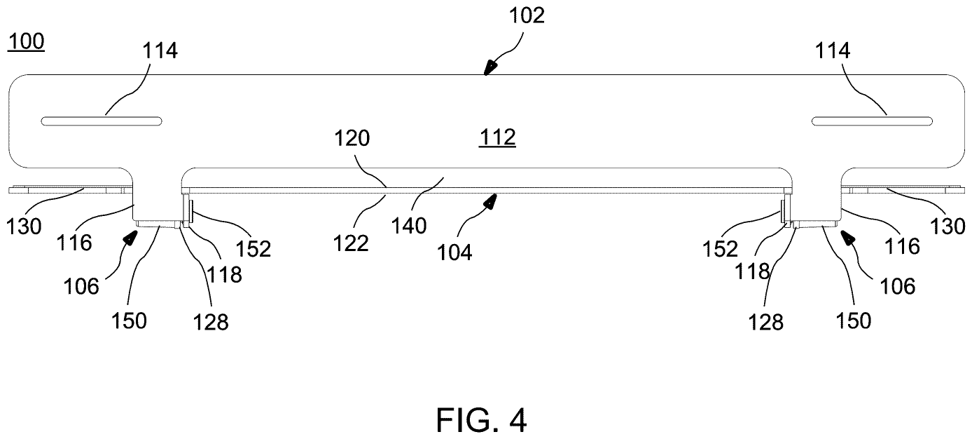

FIG. 5 is a left elevation view of the mounting bracket of FIG. 1.

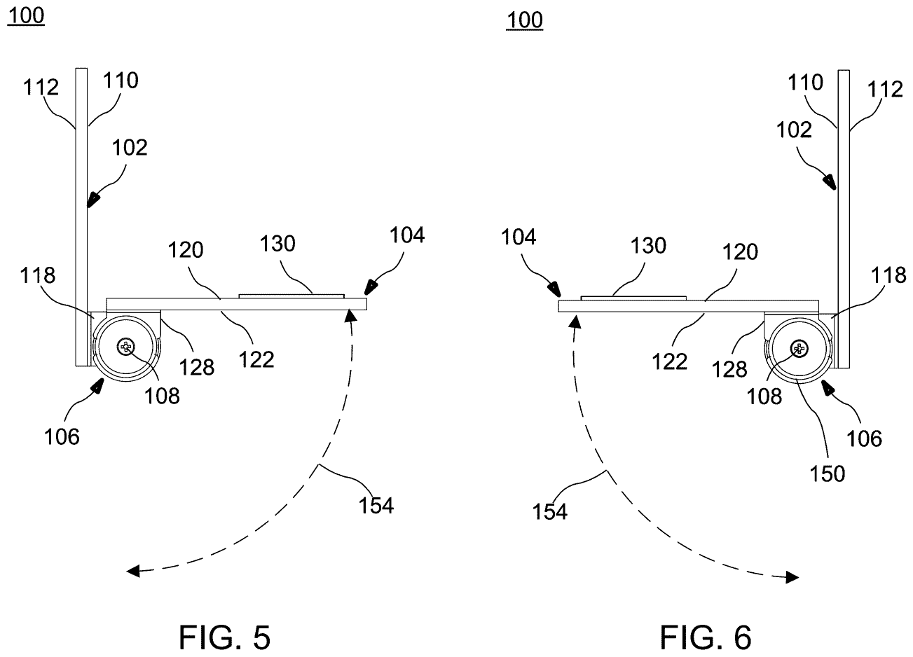

FIG. 6 is a right elevation view of the mounting bracket of FIG. 1.

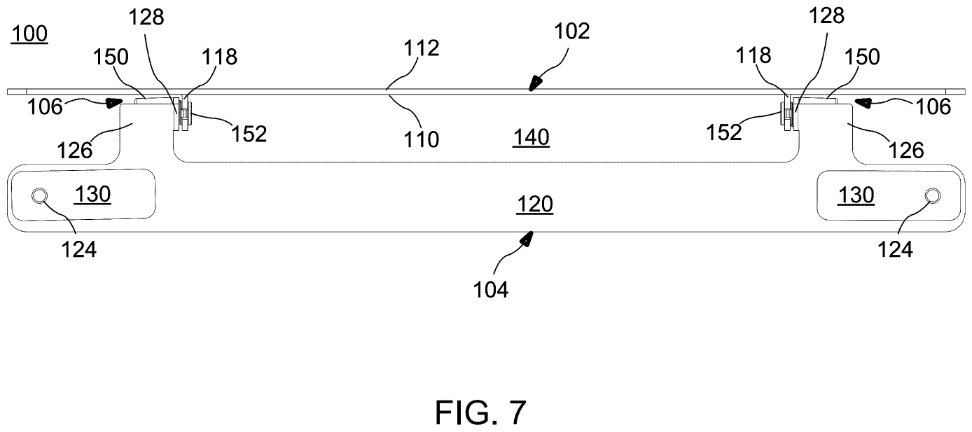

FIG. 7 is a top plan view of the mounting bracket of FIG. 1.

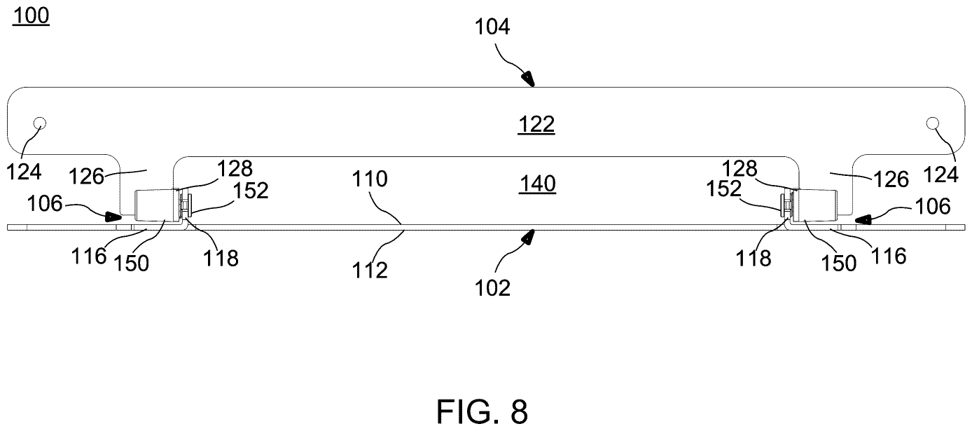

FIG. 8 is a bottom plan view of the mounting bracket of FIG. 1.

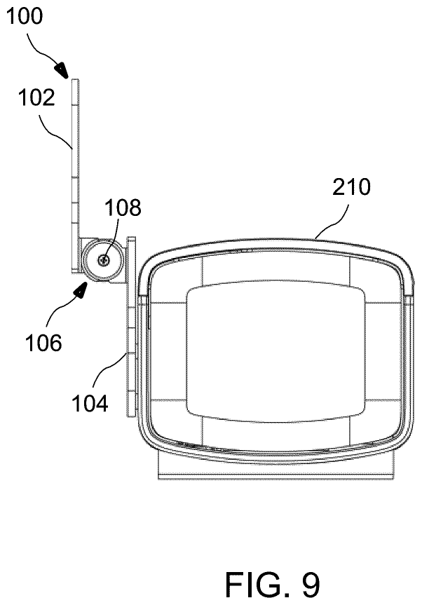

FIG. 9 shows an example of the mounting bracket of FIG. 1 with the lower plate rotated.

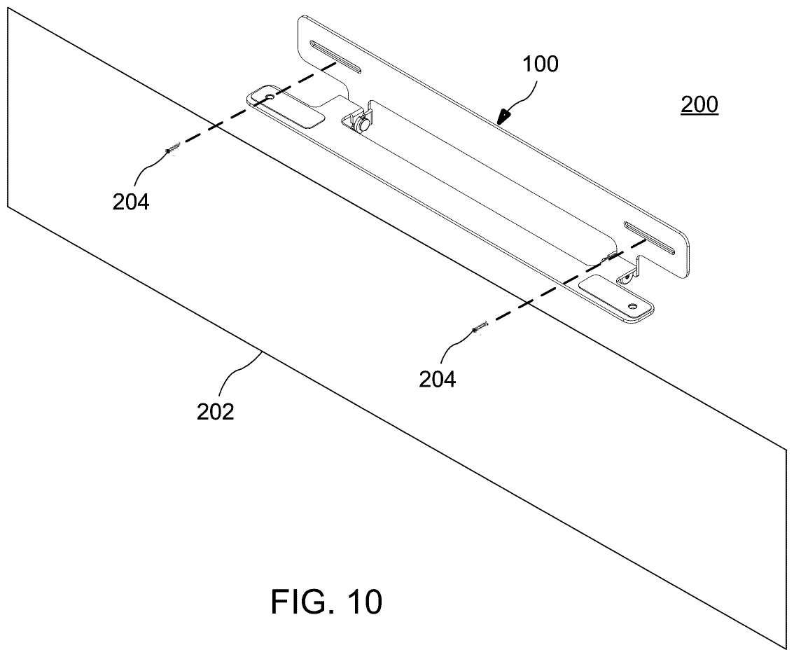

FIG. 10 shows an example of installing the mounting bracket of FIG. 1 to a wall or other mounting surface.

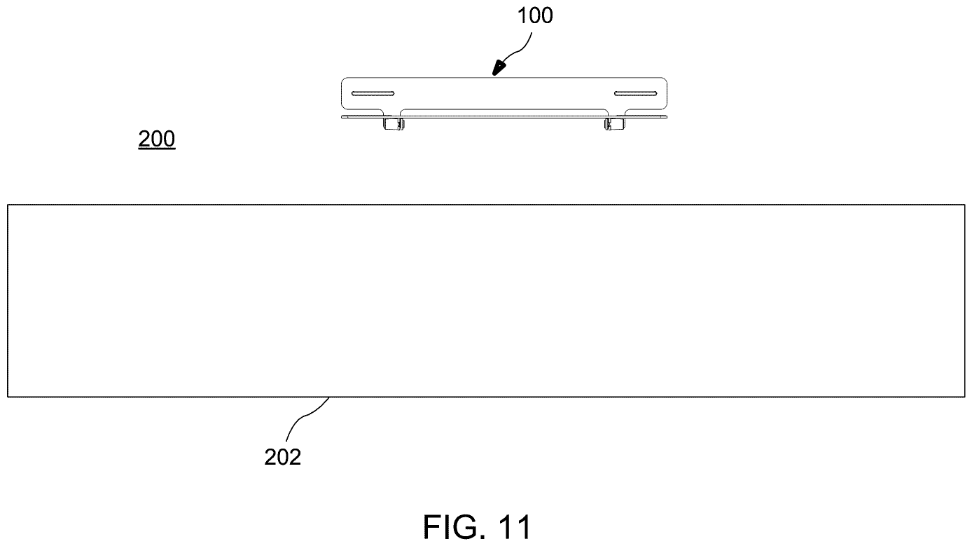

FIG. 11 shows an example of the mounting bracket of FIG. 10 after installation.

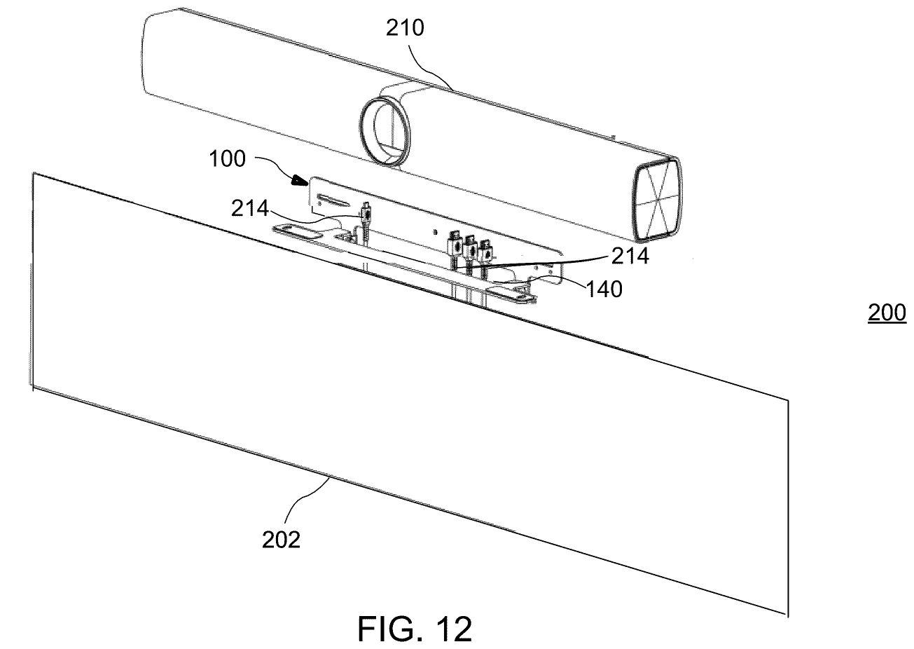

FIG. 12 shows an example of the routing of cables through the opening in the mounting bracket of FIG. 11.

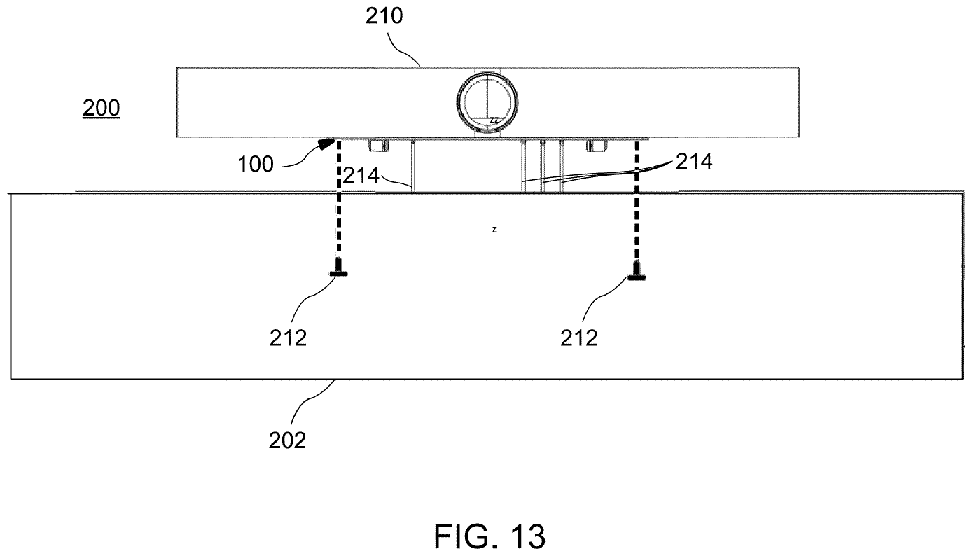

FIG. 13 shows an example of the installation of an audiovisual device to the mounting bracket of FIG. 12.

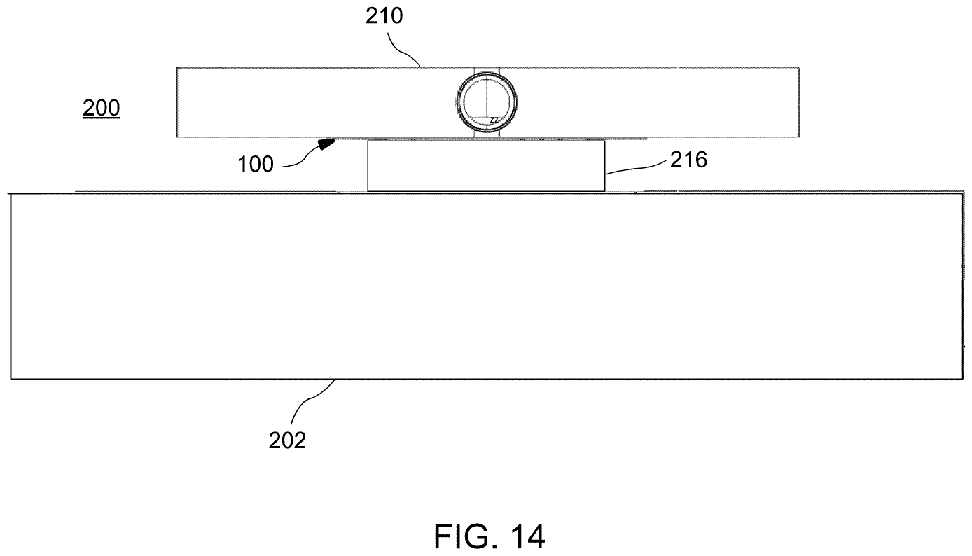

FIG. 14 shows an example of a completed installation of the audiovisual device to the mounting bracket of FIG. 13.

### DETAILED DESCRIPTION OF THE INVENTION

The present embodiments provide a mounting bracket that is installable to a wall or other mounting surface and that is configured to for mounting a Videobar 70 or other audiovisual device.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.”

### LIST OF REFERENCE NUMBERS FOR THE MAJOR ELEMENTS IN THE DRAWING

The following is a list of the major elements in the drawings in numerical order.
100 Mounting Bracket
102 Upper or Wall Plate
104 Lower or Supporting Plate
106 Hinge/Clutch Assembly
108 Pivot Point
110 Front Surface
112 Rear Surface
114 Slots
116 Extension
118 Arm
120 Top Surface
122 Bottom Surface
124 Screw Holes
126 Extension
128 Arm
130 Grip Pads
140 Pass-Through Opening
150 Assembly Body
152 End Portion
154 Path of Rotation
200 Wall
202 Display
204 Wall Screws
210 Audiovisual Device
212 Mounting Screws
214 Cables
216 Cable Shroud

### MODE(S) FOR CARRYING OUT THE INVENTION

The embodiment described herein in the context of a mounting bracket but is not limited thereto, except as may be set forth expressly in the appended claims.

Referring first to FIGS. 1-8, a mounting bracket 100 for mounting an audiovisual device, such as a Crestron® Videobar 70, to a wall or other mounting surface is shown according to an embodiment. More particularly, FIG. 1 is a top perspective view of the mounting bracket 100, FIG. 2 is a bottom perspective view, FIG. 3 is a front elevation view, FIG. 3A is an enlarged view of region “A” of FIG. 3, FIG. 4 is a rear elevation view, FIG. 5 is a left elevation view, FIG. 6 is a right elevation view, FIG. 7 is a top plan view, and FIG. 8 is a bottom plan view. In each of the figures, like reference numerals refer to like elements.

The mounting bracket 100 includes an upper or wall plate 102, a lower or support plate 104, and a hinge/clutch assembly 106.

The upper or wall plate 102 is configured to be mounted to the wall or other mounting surface and includes a rear surface 112 that is configured to face the wall or other mounting surface when the upper plate 102 is mounted. An opposing front surface 110 is configured to face away from the wall or other mounting surface when the upper plate 102 is mounted. A pair of slots 114 are formed in, and extend through, the upper plate 102 and are configured to receive wall screws to secure upper plate 102 to the wall or other mounting surface.

A lower region of the upper plate 102 narrows to form a pair of tabs or extensions 116 that are continuous with the remainder of the upper plate 102. An arm 118 is located at one side of each tab or extension 116, near an end of that tab or extension 116. The arm 118 extends away from the front surface 110 in a direction perpendicular to the front surface 110. One end of each arm 118 typically includes a substantially 90-degree bend where the arm 118 is joined to, or is continuous with, the side of the tab or extension 116. Another end of the arm 118 typically includes a curved end surface and has an opening (not shown) that passes completely through the width of the arm 118.

The lower or support plate 104 is configured to support the Videobar 70 or other audiovisual device and includes a top surface 120 that is configured to face the Videobar 70 or other audiovisual device when the Videobar 70 or other audiovisual device is mounted thereto. An opposing bottom surface 122 is configured to face away from the mounted Videobar 70 or other audiovisual device.

A pair of grip pads 130 are provided atop the top surface 120 and are configured to prevent the Videobar 70 or other audiovisual device from slipping off of the top surface 120 when the Videobar 70 or other audiovisual device is places atop the top surface 120. A pair of screw holes 124 are formed in, and extend through, the grip pads 130 and the lower plate 104 and are configured to receive screws for securing the Videobar 70 or other audiovisual device to the lower or support plate 104.

An inner region of the lower plate 104 narrows to form a pair of tabs or extensions 126 that are continuous with the remainder of the lower plate 104. An arm 128 is located at one side of each tab or extension 126, near an end of that tab or extension 126. The arm 128 extends away from the bottom surface 122 in a direction perpendicular to the bottom surface 122. One end of each arm 128 typically includes a substantially 90-degree bend where the arm 128 is joined to, or is continuous with, the side of the tab or extension 126. Another end of the arm 128 typically includes a curved end surface and has an opening (not shown) that passes completely through the width of the arm 128.

A pivot/clutch assembly 106 includes an assembly body 150, an end portion 152, and an intermediate section (not shown) located between the assembly body 150 and the end portion 152. Such pivot/clutch assemblies and their structure and operation are known in the art.

In an assembled mounting bracket 100, the upper or wall plate 102 and the lower or support plate 104 are positioned relative to each other in the manner shown in FIGS. 1-8. That is, the tabs or extensions 116 of the upper or wall plate 102 are arranged to be near the tabs or extensions 126 of the lower or support plate 104. More specifically, an arm 118 of the upper plate 102 is arranged to be adjacent to, and facing, a corresponding arm 128 of the lower plate 104 such that the openings (not shown) in the arms 118 and 128 overlie each other. Further, the other arm 118 of the upper plate 102 is arranged to be adjacent to, and facing, the other arm 128 of the lower plate 104 such that the openings (not shown) in those arms 118 and 128 similarly overlie each other.

Connecting the upper or wall plate 102 and the lower or support plate 104, as well as controlling the movement of the lower or support plate 104 with respect to upper or wall plate 102, are a pair of a hinge/clutch assemblies 106. Each hinge/clutch assembly 106 is located at the ends of a respective pair of adjacent tabs 116 and 118 and passes though the overlying openings formed in the arms 118 and 128 of that pair of adjacent tabs 116 and 126. More specifically, the assembly body 150 of the hinge/clutch assembly 106 is located adjacent to the front surface 110 of the tab or extension 116 and adjacent to the bottom surface 122 of the corresponding tab or extension 126. The assembly body 150 is also disposed adjacent to the overlying openings (not shown) formed in the arms 118 and 128 that extend from those two tabs 116 and 126. Further, the intermediate section (not shown) of the hinge/clutch assembly 106 extends through the overlying openings formed in these arms 118 and 128. Additionally, the end portion 152 of the hinge/clutch assembly 106 is located on an opposing side of the overlying openings formed in the arms 118 and 128, away from the tabs 116 and 126.

The pair of hinge/clutch assemblies 106 enable the lower or support plate 104 to be manually rotated about a pivot point 108 that is common to the two hinge/clutch assemblies 106. The range of rotation permitted by the pair of hinge/clutch assemblies 106 is shown by the angular path 154, shown in FIGS. 5 and 6. After manual rotation, the clutch mechanism within each hinge/clutch assembly 106 holds the hinge/clutch assembly 106 in place and prevents inadvertent further rotation of the lower or support plate 104.

FIG. 9 illustrates an example of the mounting bracket 100 showing the lower or support plate 104 after being manually rotated about the pivot point 108. As examples, the lower or support plate 104 may be rotated from the angle shown in FIGS. 1-8 to the angle shown in FIG. 9, from another angle to the angle shown in FIG. 9, or from the angle shown in FIGS. 1-8 to yet another angle.

The example shown in FIG. 9 also shows an audiovisual device 210, such as a Crestron® Videobar 70, mounted to the lower or support plate 104. Rotating the lower or support plate 104 to the angle shown in FIG. 9 permits access to cabling connected to the audiovisual device that traverses through a pass-through opening 140 formed between the upper or wall plate 102 and the lower or support plate 104, as shown in FIGS. 1-4 and 7-8.

FIGS. 10-14 illustrate an example of an installation of a wall bracket 100 to a wall 200 or other mounting surface followed by installation of an audiovisual device 210, such as a Crestron® Videobar 70, to the wall bracket 100.

FIG. 10 shows a display 202 that was previously mounted to a wall 200 or other mounting surface, such as in a conference room, lecture room, or other location. An audiovisual device 210, such as a Crestron® Videobar 70, is to be mounted to the wall 200 at a location above the display. After the desired mounting location is determined, holes may be drilled in the wall at locations where wall screws or wall anchors are to be driven. Another drill hole may be provided through which data and power cables are to pass through. Such cables are intended to be routed through the wall for the audiovisual device 210. FIG. 11 shows the mounting bracket 100 after the mounting bracket 100 is mounted to the wall 200.

FIG. 12 shows the audiovisual device 210, such as the Crestron® Videobar 70, that is to be mounted to the mounting bracket 100. Also shown are various data and power cables 214 which are to be connected to the audiovisual device 210. The data and power cables 214 may have been routed through the opening in the wall for connecting the audiovisual device 210 to other conference room systems and devices.

FIG. 13 shows the mounting bracket 100 with the audiovisual device 210 disposed atop the top surface 120 of the lower or supporting plate 104. Here, the data and power cables 214 have been routed through the pass-through opening 140 in the mounting bracket 100 and connected to the appropriate terminals in the audiovisual device 210. A pair of mounting screws 212 pass through the openings 124 in the lower or supporting plate 104 from below and secure the audiovisual device 210 to the lower or supporting plate 104.

FIG. 14 shows the mounting bracket 100 after the audiovisual device 210 has been secured to the mounting bracket 100. A cable shroud 216 may be used to hide the exposed wires and cables. An example of such a cable shroud is described in U.S. application Ser. No. 29/987,910, titled “Cable Shroud for Electronic Device” and filed Jan. 28, 2025, the disclosure of which is incorporated herein by reference.

Thus, the mounting bracket 100 provides for optimal use of the mounted audiovisual device 210.

### INDUSTRIAL APPLICABILITY

To solve the aforementioned problems, the present embodiments provide a mounting bracket that is securable to a wall or other mounting surface and configured for mounting an audiovisual device, such as a Crestron® Videobar 70.

It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments may be practiced without such specific details.

Although the features and elements of aspects of the embodiments are described as being in particular combinations, each feature or element may be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The above-described embodiments are intended to be illustrative in all respects, rather than restrictive, of the embodiments. Thus, the embodiments are capable of many variations in detailed implementation that may be derived from the description contained herein by a person skilled in the art. No element, act, or instruction used in the description of the present application should be construed as critical or essential to the embodiments unless explicitly described as such. Also, as used herein, the article “a” is intended to include one or more items.

In addition, the above disclosed methods are not meant to limit the aspects of the embodiments, or to suggest that the aspects of the embodiments should be implemented following the aforementioned methods. The purpose of the aforementioned methods is to facilitate the understanding of one or more aspects of the embodiments and to provide the reader with one or many possible implementations of the processed discussed herein. It should be understood by one of ordinary skill in the art that the steps of the aforementioned methods may be performed in a different order and that some steps may be eliminated or substituted.

All United States patents and applications, foreign patents, and publications discussed above are hereby incorporated herein by reference in their entireties.

### ALTERNATE EMBODIMENTS

Alternate embodiments may be devised without departing from the spirit or the scope of the embodiments.

What is claimed is:

1. A mounting bracket, comprising:
(a) a first plate configured to be securable to a vertical mounting surface;
(b) a second plate configured to be securable to an audiovisual device; and
(c) at least one hinge/clutch assembly having a pivot axis, the first plate and the second plate each being attached at one end to the at least one hinge/clutch assembly such that the second plate is rotatable away from the first plate at least part way about the pivot axis of the at least one hinge/clutch assembly.

2. The mounting bracket of claim 1, wherein the first plate includes
(a) a first surface that is configured to face the mounting surface upon the first plate being secured to the mounting surface, and
(b) an opposing second surface that is configured to face away from the mounting surface upon the first plate being secured to the mounting surface.

3. The mounting bracket of claim 2, wherein the second plate includes
(a) a first surface that is configured to face the audiovisual device upon the audiovisual device being secured to the second plate, and
(b) an opposing second surface that is configured to face away from the audiovisual device upon the audiovisual device being secured to the second plate.

4. The mounting bracket of claim 3, further comprising
(a) at least one grip pad attached to the first surface of the second plate.

5. The mounting bracket of claim 3, wherein
(a) the one end of the first plate narrows to form at least one extension region.

6. The mounting bracket of claim 5, further comprising
(a) a first arm disposed adjacent to one side of the at least one extension region of the first plate and extending away from, and perpendicular to, the second surface of the first plate.

7. The mounting bracket of claim 6, wherein
(a) the one end of the second plate narrows to form at least one extension region.

8. The mounting bracket of claim 7, further comprising
(a) a second arm disposed adjacent to one side of the at least one extension region of the second plate and extending away from, and perpendicular to, the second surface of the second plate.

9. The mounting bracket of claim 8, wherein
(a) the first arm is disposed adjacent to the second arm and has an end portion that overlaps an end portion of the second arm, and
(b) a first opening formed in the end portion of the first arm overlies a second opening formed in the end portion of the second arm.

10. The mounting bracket of claim 9, wherein
(a) a body portion of the at least one hinge/clutch assembly is disposed on one side of the first and second openings, an end portion of the at least one hinge/clutch assembly is disposed on an opposing side of the first and second openings, and a remaining portion of the at least one hinge/clutch assembly extends through the first and second openings, and
(b) the pivot axis extends through the first and second openings.

11. The mounting bracket of claim 1, wherein
(a) a gap is formed between the first plate and the second plate, the gap being configured to permit cabling of the audiovisual device to pass through the gap.

12. The mounting bracket of claim 1, wherein
(a) the at least one hinge/clutch assembly is configured to be rotatable about the pivot axis upon exertion of a force on the second plate and to be fixed upon removal of the force.

13. A mounting bracket, comprising:
(a) a first plate configured to be securable to a vertical mounting surface, the first plate narrowing at one end to form at least one extension region, a first arm being disposed adjacent to one side of the at least one extension region and extending away from, and perpendicular to, a surface of the first plate;
(b) a second plate configured to be securable to an audiovisual device, the second plate narrowing at one end to form at least one further extension region, a second arm being disposed adjacent to one side of the at least one further extension region and extending away from, and perpendicular to, a surface of the second plate; and
(c) at least one hinge/clutch assembly having a pivot axis;
(d) wherein
(1) the first arm is disposed adjacent to the second arm and has an end portion that overlaps an end portion of the second arm,
(2) a first opening formed in the end portion of the first arm overlies a second opening formed in the end portion of the second arm,
(3) a body portion of the at least one hinge/clutch assembly is disposed on one side of the first and second openings, an end portion of the at least one hinge/clutch assembly is disposed on an opposing side of the first and second openings, and a remaining portion of the at least one hinge/clutch assembly extends through the first and second openings, and
(4) the pivot axis extends through the first and second openings, the second plate thereby being rotatable away from the first plate at least part way about the pivot axis of the at least one hinge/clutch assembly.

14. The mounting bracket of claim 13, wherein
(a) the first plate narrows at one end to form a pair of extension regions, each having a respective first arm disposed adjacent to one side of that extension region and extending away from, and perpendicular to, the surface of the first plate.

15. The mounting bracket of claim 14, wherein
(a) the second plate narrows at one end to form a pair of further extension regions, each having a respective second arm disposed adjacent to one side of that further extension region and extending away from, and perpendicular to, the surface of the second plate.

16. The mounting bracket of claim 15, wherein
(a) the first arm of each one of the pair of extension regions is disposed adjacent to the second arm of a corresponding one of the pair of further extension regions and has an end portion that overlaps an end portion of that second arm.

17. The mounting bracket of claim 16, wherein
(a) a first opening formed in the end portion of each first arm overlies a second opening formed in the end portion of its adjacent second arm.

18. The mounting bracket of claim 17, wherein
(a) the at least one hinge/clutch assembly comprises
(1) a pair of hinge/clutch assemblies,
(2) an end of one of the pair of extension regions of the first plate and an adjacent end of one of the pair of further extension regions of the second plate are each attached to one of the pair of hinge/clutch assemblies, and
(3) an end of another of the pair of extension regions of the first plate and an adjacent end of another of the pair of further extension regions of the second plate are each attached to another of the pair of hinge/clutch assemblies, whereby
(4) the pair of hinge/clutch assemblies have a common pivot axis.

19. The mounting bracket of claim 18, wherein
(a) each one of the pair of hinge/clutch assemblies is configured to be rotatable about the common pivot axis upon exertion of a force on the second plate and fixed upon removal of the force.

20. A mounting bracket, comprising:
(a) a first plate configured to be securable to a vertical mounting surface, the first plate including
(1) a first surface that is configured to face the mounting surface upon the first plate being secured to the mounting surface, and
(2) an opposing second surface that is configured to face away from the mounting surface upon the first plate being secured to the mounting surface,
(3) the first plate narrowing at one end to form a pair of extension regions, each having a respective first arm disposed adjacent to one side of that extension region and extending away from, and perpendicular to, the second surface of the first plate;
(b) a second plate configured to be securable to an audiovisual device, the second plate including
(1) a first surface that is configured to face the audiovisual device upon the audiovisual device being secured to the second plate, and
(2) an opposing second surface that is configured to face away from the audiovisual device upon the audiovisual device being secured to the second plate,
(3) the second plate narrowing at one end to form a pair of further extension regions, each having a respective second arm disposed adjacent to one side of that further extension region and extending away from, and perpendicular to, the second surface of the second plate, wherein
(4) the first arm that extends from each one of the pair of extension regions of the first plate is disposed adjacent to the second arm that extends from a corresponding one of the pair of further extension regions of the second plate and has an end portion that overlaps an end portion of that second arm, and
(5) a first opening formed in the end portion of each first arm overlies a second opening formed in the end portion of its adjacent second arm; and
(c) a pair of hinge/clutch assemblies, wherein
(1) an ending of one of the pair of extension regions of the first plate and an adjacent ending of one of the pair of further extension regions of the second plate are each attached to a respective one of the pair of hinge/clutch assemblies, such that
(A) a body portion of that hinge/clutch assembly is disposed on one side of the overlying first and second openings respectively formed in the end portions of the first and second arms that respectively extend from one of the pair of extension regions of the first plate and the one of the pair of further extension regions of the second plate,
(B) an end portion of that hinge/clutch assembly is disposed on an opposing side of the overlying first and second openings, and
(C) a remaining portion of that hinge/clutch assembly extends through the overlying first and second openings, and
(2) an ending of another of the pair of extension regions of the first plate and an adjacent ending of another of the pair of further extension regions of the second plate are each attached to another of the pair of hinge/clutch assemblies, such that
(A) a body portion of that hinge/clutch assembly is disposed on one side of the overlying first and second openings respectively formed in the end portions of first and second arms that respectively extend from another of the pair of extension regions of the first plate and another of the pair of further extension regions of the second plate,
(B) an end portion of that hinge/clutch assembly is disposed on an opposing side of the overlying first and second openings, and
(C) a remaining portion of that hinge/clutch assembly extends through the overlying first and second openings,
(3) the pair of hinge/clutch assemblies thereby having a common pivot axis, each one of the pair of hinge/clutch assemblies being configured to be rotatable about the common pivot axis upon exertion of a force on the second plate and fixed upon removal of the force;
(d) wherein a gap is formed between the first plate and the second plate, the gap being configured to permit cabling of the audiovisual device to pass through the gap.
